(19) United States
(12) Patent Application Publication
(10) Pub. No.: US 2023/0282377 A1
(43) Pub. Date: Sep. 7, 2023

(54) Processing method for improving corrosion resistance of iron and steel materials in lead or lead-bismuth

(71) Applicant: Xi'an Jiaotong University, Xi'an (CN)

(72) Inventors: Di Yun, Xi 'an (CN); Yuwen Xu, Xi 'an (CN); Wei Yan, Xi 'an (CN); Yanfen Li, Xi 'an (CN); Long Gu, Xi 'an (CN); Jie Qiu, Xi 'an (CN); Shaoqiang Guo, Xi 'an (CN); Wenbo Liu, Xi 'an (CN); Cunfeng Yao, Xi 'an (CN)

(21) Appl. No.: 17/697,945

(22) Filed: Mar. 18, 2022

(30) Foreign Application Priority Data
Mar. 4, 2022 (CN) 202210213710.7

(51) Int. Cl. G21C 15/28; C22C 38/18; C22C 38/04; C23C 10/54; C23C 10/60

(52) U.S. Cl. CPC G21C 15/28; C22C 38/18; C22C 38/04; C23C 10/54; C23C 10/60; G21C 1/02

(57) ABSTRACT

The invention relates to the technical field of nuclear reactor materials, in particular to a processing method for improving the corrosion resistance of iron and steel materials in lead or lead-bismuth, comprising the following steps: selecting iron and steel materials containing Mn and Cr elements, using high-energy fast neutrons generated by fission as the radiation source, and performing irradiation on the iron and steel material so that Mn and Cr elements diffuse to the surface of the iron and steel material to form a dense oxide film, so as to complete the improvement of the corrosion resistance of the iron and steel material. The invention enhances the formation of the dense-structured oxide layer by irradiation. The oxide layer has good protection and self-healing properties in irradiation environment, and a new solution is proposed for enhancing the corrosion resistance of steel in lead and lead-bismuth coolant fast reactors.

### BACKGROUND OF THE INVENTION

### 1. Field of the Invention

The invention relates to the technical field of nuclear reactor materials, in particular to a processing method for improving the corrosion resistance of iron and steel materials in lead or lead-bismuth coolants.

### 2. Description of the Related Art

Fast neutron reactors (referred to as fast reactors) can greatly improve the utilization rate of uranium resources and realize closed fuel circulation. Lead and lead-bismuth eutectic alloys are one of the candidate coolants for fast reactors.

At high temperature, lead and lead-bismuth coolants can severely erode steel as container and structural material. Selective dissolution of steel and intergranular corrosion can cause material failure, and flowing coolant can further accelerate corrosion. For the corrosion of iron and steel materials in lead and lead-bismuth and the degradation of their mechanical properties, currently there are mainly two ways to deal with them: first, material surface oxidation; second, material surface coating. Material surface oxidation refers to controlling the oxygen content in lead or lead-bismuth to form an oxide layer on the surface of the material thus protects the material. For example, at 400° C. and 700° C., suitable oxygen levels in lead alloys are 10-4 wt % and 10-6 wt %, respectively. The rupture of the oxide layer leads to continuing oxidizing of the internal steel, forming an oxide layer that can self-heal to a certain extent. Protecting iron and steel materials by forming an oxide layer puts forward higher requirements for coolant oxygen control. Excessive oxygen content will lead to the oxidation of the coolant, which may cause serious consequences such as coolant blockage, while insufficient oxygen content will lead to the dissolution of the oxide layer and the erosion of the steel matrix. At high temperatures, this protection method may fail when dissolution and erosion caused by coolants is intensified. Material surface coating refers to, for example, applying an aluminum alloy coating to the surface of the material, which is still protective after 1500 hours in oxygen-controlled liquid lead at 550° C. The disadvantage of the surface coating is the risk of spalling failure.

In order to solve the above problems, improve the corrosion resistance of iron and steel structural materials in lead or lead-bismuth, and prolong the service life of the materials, the invention proposes a processing method for improving the corrosion resistance of iron and steel materials in lead or lead-bismuth.

### SUMMARY OF THE INVENTION

In order to solve the above deficiencies in the prior art, the invention provides a processing method for improving the corrosion resistance of iron and steel materials in lead or lead-bismuth, so as to increase the service time of structural materials or the life of fuel cladding, thereby improving the economy and safety of fast reactors.

A processing method for improving the corrosion resistance of iron and steel materials in lead or lead-bismuth of the invention is realized by the following technical solutions:

A processing method for improving the corrosion resistance of iron and steel materials in lead or lead-bismuth, comprising the following steps:

selecting iron and steel materials containing Mn and Cr elements, using high-energy fast neutrons generated by fission as the radiation source, and performing irradiation on the iron and steel material, so as to complete the improvement of the corrosion resistance of iron and steel materials.

Further, the iron and steel material is ferritic martensitic steel; the Cr content is 8-10 wt %, and the Mn content is 0.5-1.5 wt %.

Further, the irradiation dose of the irradiation treatment is 1-700 dpa.

Further, the temperature of the irradiation treatment is 400-700° C.

Further, the thickness of the dense oxide film is greater than or equal to 30 nm.

Further, the time of the irradiation treatment is greater than or equal to 10 minutes.

Further, the thickness of the dense oxide film is greater than or equal to 30 nm.

Compared with the prior art, the invention has the following advantageous effects:

The invention firstly utilizes irradiation to form a continuous, uniform and tight oxide layer rich in Cr and Mn on the surface of iron and steel materials, which could protect the material substrate in the early stage of the coolant operation after entering the lead or lead-bismuth environment. After that, the reactor will be exposed to neutron irradiation during operation, and the oxidation process promoted by irradiation enhanced diffusion can prevent the continuous thinning of the oxide layer due to the dissolution and erosion of lead or lead-bismuth, so as to achieve lasting protection of the oxide layer. In addition, using the characteristics of iron and steel materials itself to generate an oxide layer, in the case of loss of densification of the oxide layer, the dissolved atoms would be supplemented with irradiation enhanced diffusion and a self-healing capability is achieved.

The invention enhances the formation of the dense-structured oxide layer by irradiation. The oxide layer has good protection and self-healing properties in irradiation environment, and a new solution is proposed for enhancing the corrosion resistance of steel in lead and lead-bismuth coolant fast reactors.

The method of the invention improves the corrosion resistance of iron and steel materials in lead or lead-bismuth, and reduces the consumption of iron and steel materials by oxidation corrosion; in addition, the invention utilizes the irradiation environment in the reactor to promote the growth of the oxide layer, so that the oxide layer has self-healing ability.

### BRIEF DESCRIPTION OF THE DRAWINGS

FIG. 1 is a schematic diagram of the oxide layer formed by irradiation acceleration in Embodiment 1;

FIG. 2 is a distribution diagram of Fe element in the oxide layer formed by irradiation acceleration in Embodiment 1;

FIG. 3 is a distribution diagram of Cr element in the oxide layer formed by irradiation acceleration in Embodiment 1;

FIG. 4 is a distribution diagram of Mn element in the oxide layer formed by irradiation acceleration in Embodiment 1;

FIG. 5 is a distribution diagram of O element in the oxide layer formed by irradiation acceleration in Embodiment 1;

FIG. 6 is a distribution diagram of V element in the oxide layer formed by irradiation acceleration in Embodiment 1;

FIG. 7 is a schematic diagram of the self-healing of the oxide layer on the surface of iron and steel materials under irradiation enhanced diffusion.

### DETAILED DESCRIPTION OF THE PREFERRED EMBODIMENTS

The technical solutions in the embodiments of the invention will be clearly and completely described hereinafter with reference to the drawings in the embodiments of the invention.

### Embodiment 1

The invention provides a processing method for improving the corrosion resistance of iron and steel materials in lead or lead-bismuth, comprising the following steps:

using the 14 MeV high-energy fast neutrons generated by fission to irradiate steel materials at a temperature of 700° C., the irradiation dose is 700 dpa, so that the Mn and Cr atoms in the iron and steel material diffuse to the surface to form a dense oxide film, and the thickness of the dense oxide film is 30 nm after irradiation for 10 minutes, so as to complete the improvement of the corrosion resistance of the material.

The iron and steel material is ferritic martensitic steel; the Cr content is 10 wt %, and the Mn content is 1.5 wt %.

### Embodiment 2

The invention provides a processing method for improving the corrosion resistance of iron and steel materials in lead or lead-bismuth, comprising the following steps:

using the 14 MeV high-energy fast neutrons generated by fission to irradiate steel materials at a temperature of 500° C., the irradiation dose is 300 dpa, so that the Mn and Cr elements in the iron and steel material diffuse to the surface of the iron and steel material to form a dense oxide film, and the thickness of the dense oxide film is 40 nm after irradiation for 10 hours, so as to complete the improvement of the corrosion resistance of the iron and steel material.

The iron and steel material is ferritic martensitic steel; the Cr content is 9 wt %, and the Mn content is 1 wt %.

### Embodiment 3

The invention provides a processing method for improving the corrosion resistance of iron and steel materials in lead or lead-bismuth, comprising the following steps:

using the 14 MeV high-energy fast neutrons generated by fission to irradiate steel materials at a temperature of 400° C., the irradiation dose is 100 dpa, so that the Mn and Cr elements in the iron and steel material diffuse to the surface of the iron and steel material to form a dense oxide film, and the thickness of the dense oxide film is 50 nm after irradiation for 30 hours, so as to complete the improvement of the corrosion resistance of the iron and steel material.

The iron and steel material is ferritic martensitic steel; the Cr content is 8 wt %, and the Mn content is 0.5 wt %.

### Embodiment 4

The difference between this embodiment and Embodiment 1 is:

in the embodiment, the irradiation dose is 1 dpa, and the irradiation time is 60 hours.

In order to verify the effect of the method of the invention, the following model tests are carried out in the embodiment:

irradiating the fine-grained MX-ODS steel with Fe ions of 3 MeV under the condition of 550° C. and vacuum degree of 5×10⁻⁴ Pa. The irradiation dose was 70 dpa after 67 hours of irradiation, and stop irradiation.

In order to verify the effect of the treatment method of the invention, the following tests were carried out on the MX-ODS steel before and after treatment by the method of the invention.

(1) Determination of the Thickness of the Oxide Layer

The determination shows that the thickness of the oxide layer of the MX-ODS steel before being processed by the method of the invention is 3 nm; after being processed by the method of the invention, the thickness of the oxide layer of the MX-ODS steel is 40 nm.

After being processed by the method of the invention, the thickness of the oxide layer of the MX-ODS steel is more than 10 times that before being processed by the treatment, which indicates that the oxidation of the MX-ODS steel is significantly enhanced after being processed by the method of the invention. The formation of the dense-structured oxide layer on the surface of the iron and steel material is enhanced, thereby enhancing the corrosion resistance of the iron and steel material in the lead and lead-bismuth coolant fast reactor.

(2) Elemental Distribution of Oxide Layer

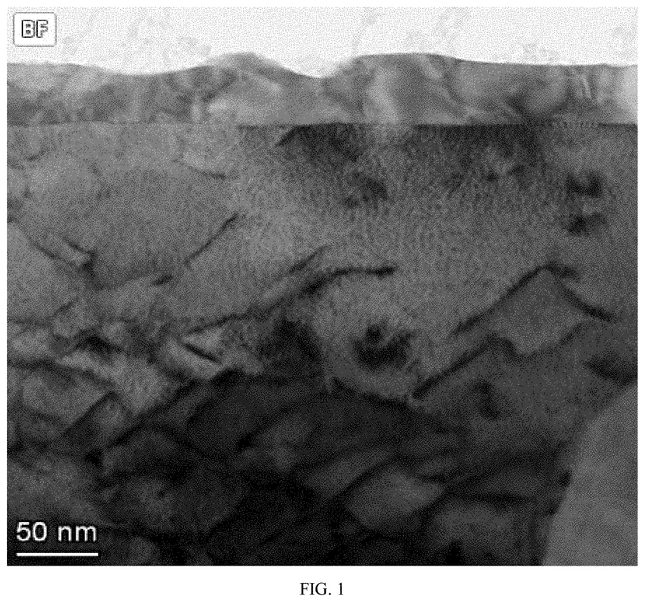

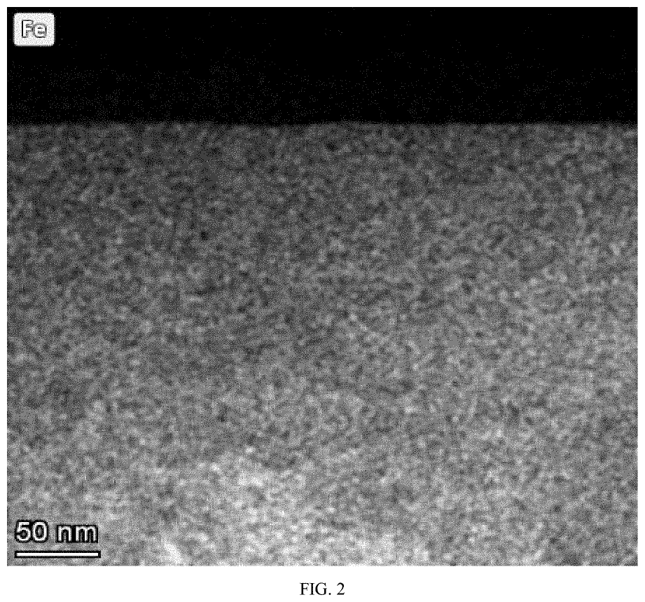

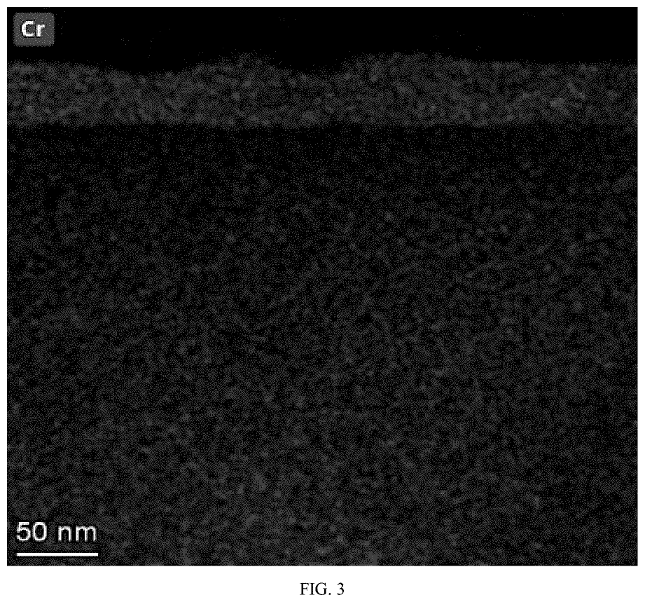

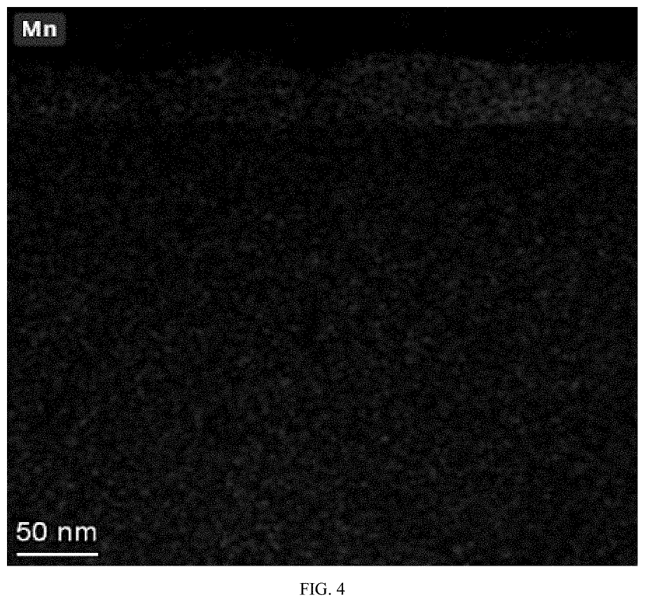

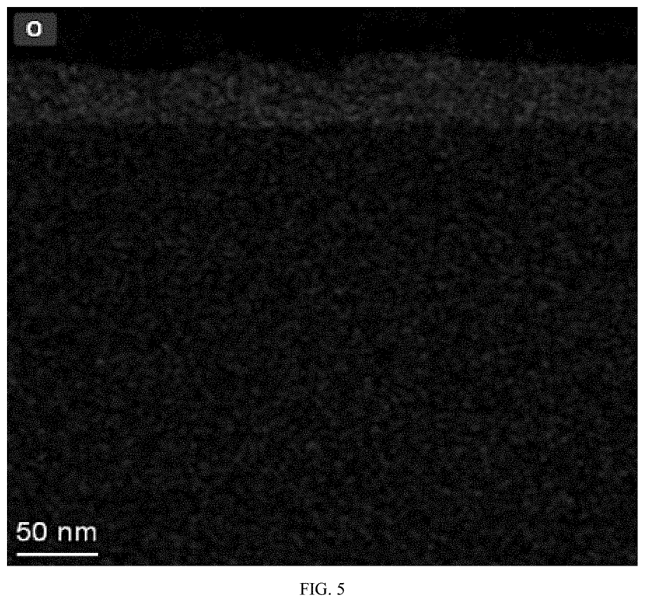

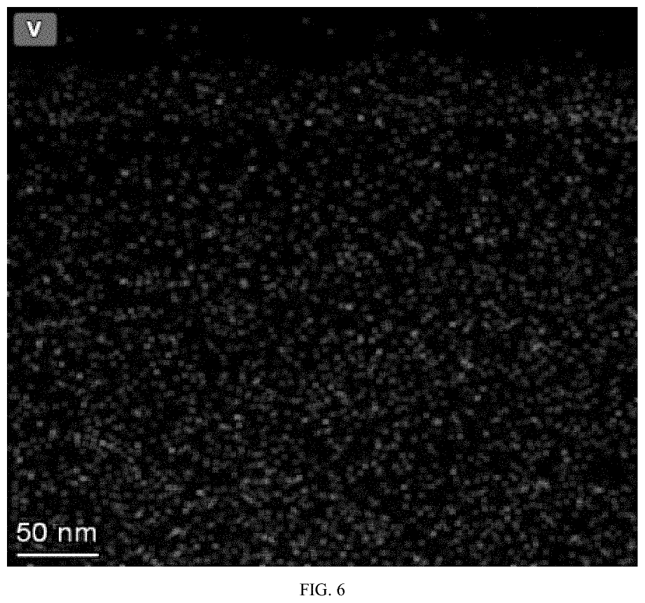

The element distribution of the surface oxide layer of the MX-ODS steel processed by the method of the invention was measured, and the results are shown in FIGS. 1-6; it can be seen that Cr and Mn spinel oxide layers are formed on the surface of MX-ODS steel after being processed by the method of the invention, and the oxide layers growing outward from the surface of the sample are continuous and complete, and are well attached to the substrate.

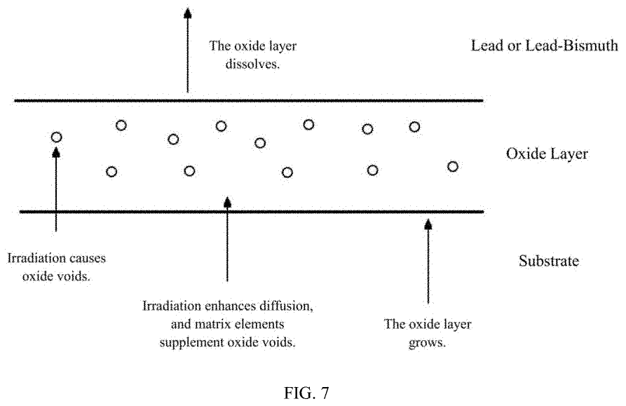

As shown in FIG. 7, the irradiation selectively enhances the diffusion of Mn and Cr elements to the surface to form a dense oxide film, and at the same time, the dissolved Mn atoms in liquid lead or lead-bismuth can be supplemented and the non-densification defects introduced by irradiation can be healed.

Under irradiation conditions, a large number of point defects are generated in the alloy matrix, and the high concentration of vacancies and the cascade collision during the irradiation process greatly enhance the diffusion of the atoms. The main constituent elements of the oxide layer, Cr and Mn, which are substitutional solute atoms in the substrate, can diffuse utilizing vacancies, therefore the element concentration at the oxide/substrate interface is maintained. The addition of Cr and Mn elements in steel is beneficial to enhance its corrosion resistance, because the dense oxides containing these elements are more capable of preventing Fe elements from diffusing outward. Compared with Fe, the free energy of formation of Cr and Mn oxides is lower and therefore the oxides are more stable. However, since their content in ferritic-martensitic steel is not high, such as Cr content is about 10 wt %, Mn is often controlled within 1 wt %, when oxidation continues, their relatively low concentrations are not sufficient to form oxides. The invention utilizes irradiation to enhance the diffusion of Cr and Mn atoms, so that Cr and Mn atoms at the interface of oxide layer/matrix can be supplemented. Even if the oxide layer is dissolved or the compactness of the oxide layer is reduced, the oxide layer would be repaired because of the supplement of Cr and Mn atoms.

In the invention, the oxide layer is formed by using Fe ion irradiation experiments at the same temperature in the reactor with a high dose. The experiment itself was designed to examine the irradiation characteristics of the samples, simulating the reactor environment, so that the oxide layer could also be generated during actual reactor operation. Ion irradiation and in-pile neutron irradiation have similar basic physical process and material degradation results. Compared with neutron irradiation, ion irradiation has series of advantages such as wide rages of controllable of experimental conditions, saving in time and money and no need of considering residual radioactivity. The effects of heavy ion irradiation and neutron irradiation on materials are the most similar, so a large number of studies use heavy ion irradiation to simulate in-pile neutron irradiation to study the possible impact of materials in the reactor environment. Compared with the oxide layer formed by pre-oxidation after surface treatment, the oxide layer in this method has the characteristics of sustainable replenishment, and even if a small area is peeled off during the operation in the reactor, there is a chance to regenerate the oxide layer.

Obviously, the embodiments above are only a part of the embodiments of the invention, but not all of the embodiments. Based on the embodiments of the invention, all other embodiments obtained by those of ordinary skill in the art without creative efforts shall fall within the protection scope of the invention.

1. A processing method for improving the corrosion resistance of iron and steel materials in lead or lead-bismuth, comprising the following steps:
selecting iron and steel materials containing Mn and Cr elements, using high-energy fast neutrons generated by fission as the radiation source, and performing irradiation on the iron and steel material so that Mn and Cr elements diffuse to the surface of the iron and steel material to form a dense oxide film, so as to complete the improvement of the corrosion resistance of the iron and steel material.

2. The processing method according to claim 1, wherein the iron and steel material is ferritic martensitic steel; the Cr content is 8-10 wt %, and the Mn content is 0.5-1.5 wt %.

3. The processing method according to claim 1, wherein the irradiation dose of the irradiation treatment is 1-700 dpa.

4. The processing method according to claim 1, wherein the temperature of the irradiation treatment is 400-700° C.

5. The processing method according to claim 1, wherein the time of the irradiation treatment is greater than or equal to 10 minutes.

6. The processing method according to claim 1, wherein the thickness of the dense oxide film is greater than or equal to 30 nm.

7. The processing method according to claim 1, wherein the irradiation treatment is carried out under vacuum, and the degree of vacuum is less than or equal to 5×10⁻⁴ Pa.
